(19) United States
(12) Patent Application Publication
(10) Pub. No.: US 2014/0173707 A1
(43) Pub. Date: Jun. 19, 2014

(54) Disabling Unauthorized Access To Online Services

(71) Applicant: Alan Roy Hollander, Needham, MA (US)

(72) Inventor: Alan Roy Hollander, Needham, MA (US)

(21) Appl. No.: 13/714,633

(22) Filed: Dec. 14, 2012

(51) Int. Cl. H04L 29/06

(52) U.S. Cl. CPC H04L 63/08
USPC 726/7

(57) ABSTRACT

The present invention relates to a method that enables a user to easily, quickly, and securely disable access to any or all of the online services they use by means of an application managed by a service provider that communicates with those online services that agree to deny access when they receive such communications. When a user denies access, no one is able to log in to any of the online services even if someone has correctly entered the user's login credentials. An “online service” as used herein encompasses any service, such as banking or credit card websites or mobile apps, connected to the Internet that enables a user to log in to the service, and also includes an online service provided by a business to its employees.

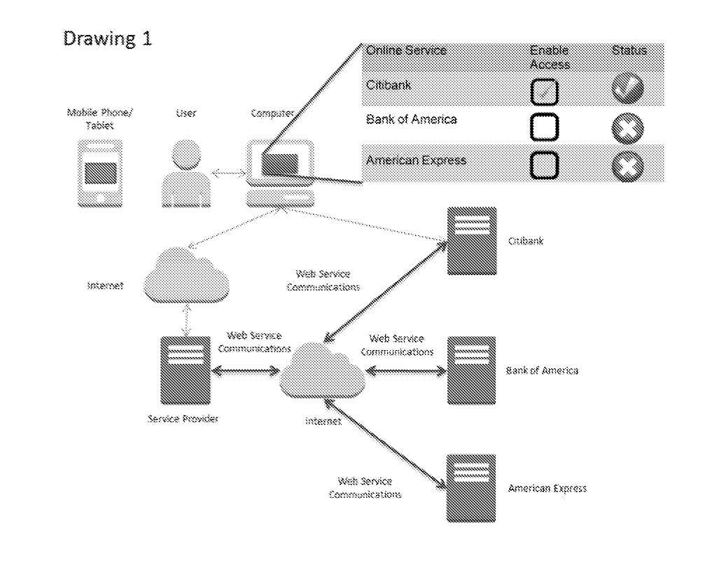

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

The present invention relates to methods to prevent hackers and other unauthorized persons from being able to log, in to a user's online services. An “online service” as used herein encompasses any service, such as banking or credit card websites or mobile apps, connected to the Internet that enables a user to log in to the service, and also includes an online service provided by a business to its employees. More specifically, the present invention relates to a method for a third-party application to communicate with a user's online services when a user enables or disables the access status to these online services.

Username and passwords, combined with other security measures, are used by most online services to authorize users to log in to their services. Unfortunately, hackers and others have been able to obtain or crack usernames and passwords and other login credentials to gain unauthorized access to online services causing financial and other losses. See, “Kill the Password: Why a String of Characters Can't Protect Us Anymore”, Mat Honan, Wired, December 2012, which is also published online on the Wired website with a date of Nov. 15, 2012. Additional security steps used in the login process, such as verification questions, have not sufficiently prevented successful hacking.

To provide additional security, some businesses supplement login credentials with a form of two-factor authentication, such as calling or texting a mobile phone and requiring the user to enter a code, but two-factor authentication is not widely adopted by public online services. While a business can require their employees to use two-factor authentication to log into its services, much of the public is deterred from using mobile phone two-factor authentication because of the delay in the login process and the risk of not being able to log in if the user does not have mobile phone coverage.

### BRIEF SUMMARY OF THE INVENTION

The technical problem is to limit the period of time during which anyone can log in to a user's online services, preferably so that no one other than the user can ever log into their online service, while making it easy, quick, and secure for the user to deny access.

In accordance with the foregoing needs, there is disclosed a method to enable a user to enable or disable access to one or more online services, such as bank and credit card websites or apps, by providing the user with an application managed by a service provider that enables the user to set the access status for each of their online services and enables web service communications between the online services and the service provider to determine if the user has enabled or disabled access.

When a user disables access to their online services, no one will be able to log in even if they use the correct user credentials. A user can limit access to the period of time when they are logged in, or can limit access to certain other time periods such as when they do not have Internet access or are not otherwise able to monitor their online services. The invention also enables users to quickly disable access to all of their online services if they suspect that an unauthorized person has gained access to their login credentials, if the user limits access to only the period of time they are logged in, and the online service prevents a second user from being able to log in during that session from another IP address, only the user would ever be able to log in to the online service.

### BRIEF DESCRIPTION OF DRAWINGS

Drawing 1 provides a visual representation of the following example. In the best embodiment of the invention:
(a) the user uses the application on either their computer or mobile phone or tablet,
(b) during the users previous session and not shown in the drawing, the user unchecked all of the checkboxes to disable access to all online services, so when the user logs in to the current session all of the status indicators are red circles with Xs,
(c) in the current session shown in the drawing, the user has selected one Participating Online Service by checking the box for Citibank which then causes the green circle with a checkmark to be displayed to show the status is enabled,
(d) the user an remain logged in to the application or can now log out if the only want to access the Citibank service,
(e) the user logs into the Citibank service,
(f) Citibank makes a request to the service provider using the service provider's web service, and receives back a response that the user's access status is enabled, and
(g) Citibank allows the user to complete the login process and access the Citibank service.

If any other person attempts to access any of the Participating Online Services when the red circle with an X is displayed, the Participating Online Service would deny access because the service provider would send a response that the user's access status is disabled.

In the alternative embodiment of the invention the Participating Online Service checks on the user's access status by making a web service request to the service provider:
(a) the user uses the application on either their computer or mobile phone or tablet,
(b) during the user's previous session and not shown in the drawing, the user unchecked all of the checkboxes to disable access to all online services, so when the user logs in in to the current session all of the status indicators are red circles with Xs,
(c) in the current session shown in the drawing, the user has selected one Participating Online Service by checking the box for Citibank,
(d) The service provider sends the user's unique identifier and access status to

Citibank using Citibank's web service,
(e) Citibank responds with the response that the post is successful,
(f) the application then displays a green circle with a checkmark to show the status is enabled,
(g) the user can remain logged in to the application or can now log out if they only want to access the Citibank service, and
(h) the user logs in to the Citibank service and is allowed access.

If any other person attempts to access any of the Participating Online Services when the red circle with an X is displayed, the Participating Online Service would deny access because the last post by the service provider would be that the user's access status is disabled.

### DETAILED DESCRIPTION OF THE INVENTION

The invention is a method to enable a user to enable or disable access to one or more online services, such as hank and credit card websites and mobile apps, by setting the access status of each of these online services in an application managed by a service provider, hereinafter referred to as the Application, communicating that status to these online services using web services, and having these online services deny access when the access status is set to disable access, hereinafter referred to as the Access Control System. The Application may be accessed using, a browser on any computer device or any device that provides computer capability, such as a smart phone or tablet, and/or may be installed on a computer or as an app on a smart phone or tablet. In the most secure use of the Access Control System, a user establishes an account with the service provider, the user logs in to the Application and changes a setting to enable access to one online service, the Application then displays that access is enabled, the user then logs in to that online service and after logging out of the online service, the user then changes the setting to disable access, and then continues in the same manner for each additional online service. An additional security measure that can be implemented but which is not necessary to implement the invention is that if someone else attempts to login to the online service during the same user session from a different IP address, the online service can deny access to the second login attempt. A less secure, but slightly easier, option would be for the user to enable access to all of the user's online services at one time and upon completion of sessions with those online services, the user changes the setting to disable access to all of the online services. Another option would be for a user to disable access only when the user is not able to monitor the user's online services such as during the night or when the user is traveling and doesn't have Internet access. Additional security measures can be implemented to secure the user's access to the Application but which are not necessary to implement the invention, such as encouraging the user to use an email address that is different than they use for their online services.

The Access Control System is established by agreement between the service provider and various online services which are hereinafter referred to as the Participating Online Services, whereby they agree to establish web services, exchange web services specifications, and establish authorization credentials.

To exchange user access status, both the service provider and the Participating Online Services identify the same user by a unique identifier that each user sets after the user registers and logs in to the Application and which the user then provides to each Participating Online Service after they log in to each Participating Online Service. The user can set the unique identifier in any number of ways, such as by making up an identifier that meets the criteria described in the Application provided that it is not identical to any other identifier used b another user of the Application or the user may select from a list of acceptable identifiers provided in the Application. When the user first provides the unique identifier to a Participating Online Service, it then sends the unique identifier and its name to the service provider using the service provider's web service and the service provider then adds the name to the user's list of Participating Online Services in the Application. The service provider securely stores all unique identifiers in a database and associates each unique identifier with a user and the user's access status as set by the user for each Participating Online Service. Each Participating Online Services securely stores the unique identifier provided by each user in a database and associates it with the user and in one embodiment of the invention, also stores the access status of the user provided by the service provider. While not required to implement the invention, in order to increase security, if the user forgets the unique identifier, the user may be required to set a new one in the Application, and then provide the new identifier to each of their Participating Online Services.

To communicate the access status as set by the user in the Application to the Participating Online Services, the service provider and the Participating Online Services implement web services using a cryptographic protocol, such as SSL or TLS, to enable the secure exchange of data and authorization credentials. The web service can be implemented using SOAP, REST, or other generally used architectures, and multiple types of web services can be used at the same time to enable different parties to use the implementation they prefer. Web services communication is nearly instantaneous so that communications to change access between enabled and disabled would occur without any noticeable delay for the user.

Each Participating Online Service modifies its login process to check the access status of the user and to enable a login only when the access status is enabled and deny a login when the access status is disabled.

In the Application the user selects from their list of Participating Online Services to enable or disable access, which selections are stored in the service provider's database and associated with the unique identifier. The user can make access selections each time they log in to the service provider's application or can make selections that would operate under a number of conditions, such as time. For example, the user can set a condition that after they login, the setting will be changed to disable after a set period of time has elapsed. The user can make individual selections for each Participating Online Service or select all or none.

In the best mode of implementing the invention, each Participating Online Service makes requests to the service provider's web service each time a user logs in to the Participating Online Service by providing the user's unique identifier and receives a response from the web service that indicates if the user associated in the service provider's database with such unique identifier has disabled online access, in which case the Participating Online Service will deny access even if the correct user credentials have been entered during the login process. An example of the body of a request from an online service to the service provider is:

<getStatus>

<Name>OnlineServiceName</Name>
<Password>GW49*upQ1x</Password>
<UserID>Hg4%xC#jipR</UserID>

</getStatus>

An example of the body of a response from the service provider is:

<getStatusResult>

<ID>Hg4%xC#jipR</ID>
<Status>1</Status>

</getStatusResult>

where the Status value of 1 means Enabled and 2 means Disabled.

In an alternative mode of implementation, the service provider makes a post to the respective web services established by each of the Participating Online Services with the user's initial access status for each of the Participating Online Services and then each time a user makes a change to the access status of their Participating Online Services the service provider makes another post, both the initial and subsequent posts providing the user's unique identifier and a value indicating whether access is enabled or disabled, in which case each Participating Online Service will store the setting to enable or disable access, and if disabled, will deny access even if the correct user credentials have been entered during a login process.

An example of the body of such a post is:

<postStatus>

<Name>ServiceProviderName</Name>
<Password>89$2MJqz*j</Password>
<UserID>Hg4%xC#jipR</UserID>
<Status>1</Status>

</postStatus>

An example of the body of a response from the Participating Online Service provider is:

<postStatusResponse>

<SuccessorErrorValue>1</SuccessorErrorValue>
<Message>Success</Message>

</postStatusResponse>

Typically in a response, a value of I means success and other values are used in case of error conditions. When the response is a success, then the Application displays that the Participating Online Service is enabled, such as changing a red circle with an X to a green circle with a checkmark. See Drawing 1.

The alternative mode requires each online service provider to implement a web service and to store the user's access status in a database.

The best mode of implementation can be used for certain Participating Online Services and the alternative mode of implementation can be used for other Participating Online Services, depending on their preference for implementation.

The methods discussed above are examples and not restrictions on how the invention may be practiced. For example, these methods may include additional acts or steps. Further, the order of the acts performed as part of these methods is not limited to the order described, unless the context clearly requires, as the acts may be performed in other orders, and one or more of the acts may be performed in series or in parallel to one or more other acts, or parts thereof. None of the claims set forth below is intended to be limited to any particular implementation unless such claim includes a limitation explicitly reciting a particular implementation.

Data processing, aspects of the invention may be implemented in software, hardware or firmware, or any combination thereof. It should be understood that the invention is not limited to a particular computer system platform, processor, operating system, or network. Also, it should be apparent to those skilled in the art that the present invention is not limited to a specific programming language or computer system.

Having thus described an inventive concept and embodiments for practicing such concept, it will be appreciated that the embodiments discussed herein are presented by way of example only and are not intended as limiting. Various alterations thereto and other embodiments will readily occur to those skilled in the art and it is intended that they be suggested by this disclosure. Moreover, although some of the examples presented herein involve specific combinations of methods, acts, or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function. The invention is thus limited only as required by the following claims and equivalents thereto.

What I claim as my invention is:

1. A method to enable a user to enable or disable access to one or more online services, comprising:
a. an account established by each user with a service provider to use an application on one or more devices connected to the Internet using login credentials that are different than used to log in to any of the user's online services,
b. a web service using a cryptographic protocol and residing on one or more servers connected to the Internet and managed by the service provider with respect to which the service provider provides to one or more online services authorization credentials and specifications,
c. a unique identifier that is set by each user and is securely stored in a database managed by the service provider and associated with the user,
d. the user providing the unique identifier to each online service after they log in to such online service, the online service securely storing the unique identifier provided by each user in a database and associating it with the user, the online service posting to the web service their authorization credentials, the unique identifier, and their name, the service provider then adding the name to the user's list of online services in the application, and the service provider setting an initial value to enabled for that online service,
e. the user logging into the application, setting the access to each online service displayed in their list to be enabled or disabled, which settings are stored in the service provider's database and associated with the unique identifier,
f. the user logging in to an online service to which they have provided their unique identifier, the online service making a request to the web service, such request consisting of the online service's authorization credentials and the user's unique identifier, and the web service sending a response consisting of a value for either enabled or disabled, and the online service enabling access if the value in the response is enabled or denying access if the value in the response is disabled even if the correct user credentials have been entered during the login process.

2. The method according to claim 1 where the user's initial access setting is set to disabled by the service provider.

3. A method to enable a user to enable or disable access to one or more online services, comprising:
a. an account established by each user with a service provider to use an application on one or more devices connected to the Internet using login credentials that are different than used to log in to any of the user's online services,
b. a web service using a cryptographic protocol and residing on one or more servers connected to the Internet and managed by the service provider with respect to which the service provider provides to one or more online services authorization credentials and specifications,
c. one or more web services using a cryptographic protocol residing on one or more servers connected to the Internet, each managed by one online service with respect to which each online service provides to the service provider authorization credentials and specifications,
d. a unique identifier that is set by each user and is securely stored in a database managed by the service provider and associated with the user,
e. the user providing the unique identifier to each online service after they log in to such online service, the online service securely storing the unique identifier provided by each user in a database and associating it with the user, the online service posting to the web service their authorization credentials, the unique identifier, and their name, the service provider then adding the name to the user's list of online services in the application, and the service provider setting an initial value to enabled for that online service,
f. the user logging into the application, setting the access to each online service displayed in their list to be enabled or disabled, which settings are stored in the service provider's database and associated with the unique identifier,
g. each time the user sets the access status for each online service and upon the initial setting of the value, the service provider making a post to each web service managed by the respective online service, consisting of the service provider's authorization credentials, the user's unique identifier, and a value indicating whether access is enabled or disabled, in which case the online service stores the value in a database and enables access if the value is enabled and denies access if the value is disabled even if the correct user credentials have been entered during the login process.

4. The method according to claim 3 where the user's initial access setting for each online service is set by the service provider to disabled.
